(19) United States
(12) Patent Application Publication
(10) Pub. No.: US 2001/0002535 A1
(43) Pub. Date: Jun. 7, 2001

(54) Combined power station

(76) Inventors: Erhard Liebig, Laufenburg (DE); Ralph Schulz, Waldshut-Tiengen (DE)

Correspondence Address: BURNS DOANE SWECKER & MATHIS L L P, POST OFFICE BOX 1404, ALEXANDRIA, VA, 22313-1404, US

(21) Appl. No.: 09/725,803

(22) Filed: Nov. 30, 2000

(30) Foreign Application Priority Data
Dec. 1, 1999 (DE) 199 57 874.5

(51) Int. Cl. F02C 6/18

(52) U.S. Cl. 60/39.182; 60/39.33

(57) ABSTRACT

In a combined power station (32) having a plurality of power islands ( L1, . . . , L3), which operate in parallel and which each comprise a gas turbine installation (3), a steam turbine (5), a generator (4), a water/steam circuit with a heat recovery steam generator (13) and a condenser (K1, . . . , K3), and associated auxiliary installations (20, 21), substantial standardization is made possible because each of the power islands (L1, . . . , L3) has its own cooling tower (KT1, . . . , KT3) associated with it, and because the cooling tower (KT1, . . . , KT3) is connected to the respective condenser (K1, . . . , K3).

The present invention relates to the field of power station technology. It concerns a combined power station as described in the preamble to claim 1.

Such a power station is known from practice.

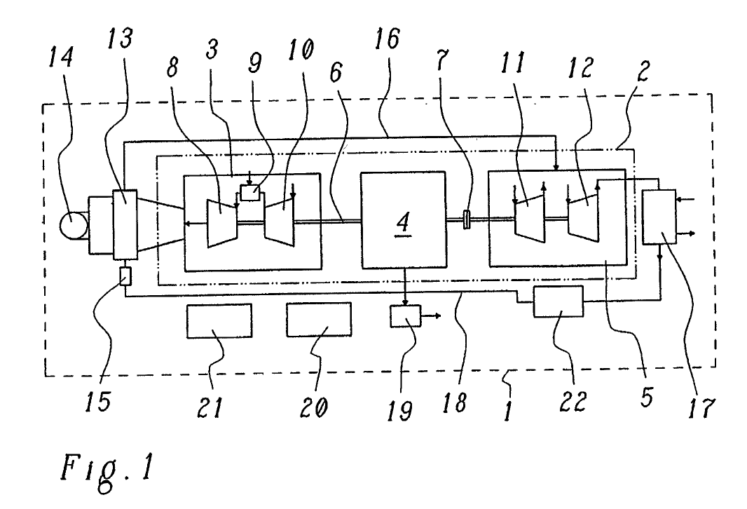

In the course of operations to standardize power station installations and make them more uniform, standardized power islands are increasingly employed as sub-groups in power stations in which the hot combustion gases from gas turbine installations are used for generating steam for steam turbines. FIG. 1 shows, as an example, such a power island, which respectively comprises a gas turbine installation, a steam turbine, a generator and a water/steam circuit in addition to associated auxiliary installations and the necessary control technology.

The central unit of the power island 1 in FIG. 1 is the so-called power train 2 (chain-dotted line), in which a gas turbine installation 3, a generator 4 and, by means of a coupling 7, a steam turbine 5 are arranged on a shaft 6 (single-shaft installation). Such a power train can likewise be standardized. The gas turbine installation 3 usually includes a compressor 10 for compressing the combustion air, a combustion chamber 9, in which a gaseous and/or liquid fuel are burnt while combustion air is being supplied, and a turbine 8, in which the hot combustion gases from the combustion chamber 9 are expanded. The turbine 8 can have a plurality of stages. Similarly, a second combustion chamber can be provided between two stages.

The hot combustion gases emerging from the turbine 8 are passed through a subsequent Heat Recovery Steam Generator (HRSG) or waste-heat boiler 13, where they are cooled, with rejection of heat to a water/steam circuit; they are subsequently rejected to atmosphere through a chimney 14. In the water/steam circuit mentioned, water from a feed-water tank 22 is pumped via a feed-water main 18 by means of a feed-water pump 15 through the heat exchanger (economizer, evaporator, superheater, etc.) arranged within the heat recovery steam generator 13 and is converted into high-pressure steam which is fed, as live steam, via a live steam main 16 to the steam turbine 5.

The steam turbine 5 usually comprises various turbine stages (high-pressure stage, medium-pressure stage, low-pressure stage), of which two (11 and 12) are shown as an example in FIG. 1. In addition to the live steam main 16, further mains—by means of which steam at different temperatures and pressure levels is exchanged—can be provided between the steam turbine 5 and the heat recovery steam generator 13. The exhaust steam finally emerging from the steam turbine 5 is condensed in a condenser 17 and pumped back as condensate into the feed-water tank 22. The condenser 17 is, in turn, connected to a cooling device which is configured as a cooling tower in the cases important to the application.

The power island 1 also includes (in addition to various auxiliary transformers) a transformer 19, which transforms the electrical power generated by the generator 4 to the level, in terms of voltage, of the network connected. The power island 1 also includes auxiliary installations 20, 21 of various types which, for example, are used to treat the water and fuel, to generate emergency electricity, to control the installation, etc.

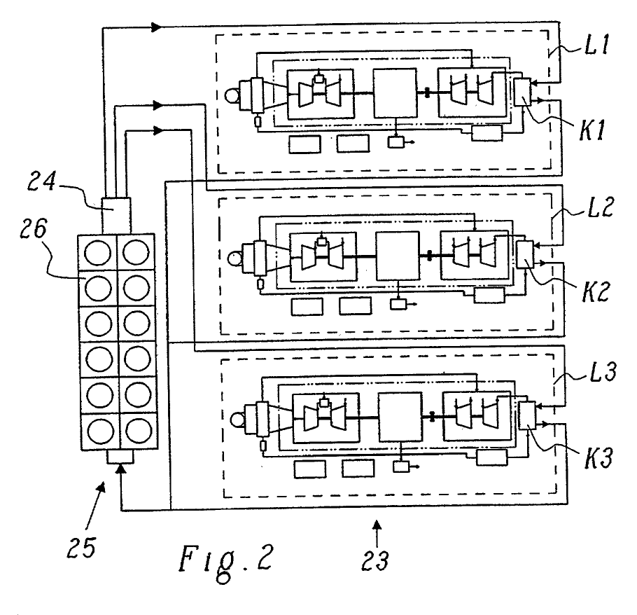

As shown in FIG. 2, a plurality of the power islands L1, . . . , L3 represented in FIG. 1 are connected in parallel in a combined power station 23 of known type in order to achieve a specified power level for the power station. The condensers K1, . . . , K3 of the various power islands L1, . . . , L3 are then connected by corresponding mains for the cooling water to a common cooling tower 25, which consists of a plurality of individual cooling tower cells 26, depending on the cooling duty required. The individual cooling water circuits converging on the cooling tower are sustained by corresponding main cooling water pumps 24, which are arranged at the cooling tower 25.

A disadvantageous feature of the design of the combined power station 23, which is represented in FIG. 2, is that although the power islands 1 or L1, . . . , L3 are standardized and combined in modular fashion to form a power station of higher power, the cooling circuits, together with the cooling tower, must be specially tailored to the particular application, depending on the number and type of the power islands 1 or L1 . . . L3. This requires additional effort in the planning and construction of the installation and makes substantial standardization of the installation parts more difficult.

The object of the invention is therefore to create a combined power station built up from power islands, which combined power station avoids the stated disadvantages of known combined power stations and, in particular, permits substantial standardization of the cooling circuits.

The object is achieved by means of the totality of the features of claim 1. The core of the invention consists in the fact that each of the power islands has its own cooling tower associated with it and is in connection with the respective condenser. By this means, the individual cooling tower can, from the outset, be matched and tailored to the individual power island, so that it is included in the modular concept.

The combined power station becomes particularly compact if, according to a first preferred embodiment of the invention, the gas turbine installation, the steam turbine and the generator are arranged on one shaft in each of the power islands and form a power train, and the associated cooling tower is arranged immediately at the power train.

If an axial exhaust steam outlet is provided on the steam turbine of the respective power train, the associated cooling tower is preferably arranged as a prolongation of the power train. If a radial exhaust steam outlet is provided on the steam turbine of the respective power train, the associated cooling tower is preferably arranged beside the power train.

A second preferred embodiment of the invention in the case of individual power islands, is distinguished by the fact that the condenser is sub-divided into a plurality of condenser sections, a plurality of main cooling water pumps are present and the cooling tower comprises a plurality of cooling tower cells operating in parallel, and that there is a specified association between the condenser sections, the main cooling water pumps and the cooling tower cells. This permits the realization, in modular form, of very simple standardized steps in the cooling duty.

A preferred development of this embodiment is distinguished by the fact that a main cooling water pump is associated with each of the condenser sections, and the main cooling water pumps are respectively in connection with the condenser sections by means of separate supply mains. Another preferred development is distinguished by the fact that one or more cooling tower cell(s) is (are) associated with each of the condenser sections, and the one or more cooling tower cell(s) are each in connection with the condenser sections by means of separate return mains.

Further embodiments follow from the dependent claims.

The invention is described in more detail below in association with the drawing, using embodiment examples. In the drawing

FIG. 1 shows the diagram of a power island, known per se, for a combined power station;

FIG. 2 shows the diagram of a combined power station according to the prior art with a plurality of power islands according to FIG. 1 and a common cooling tower;

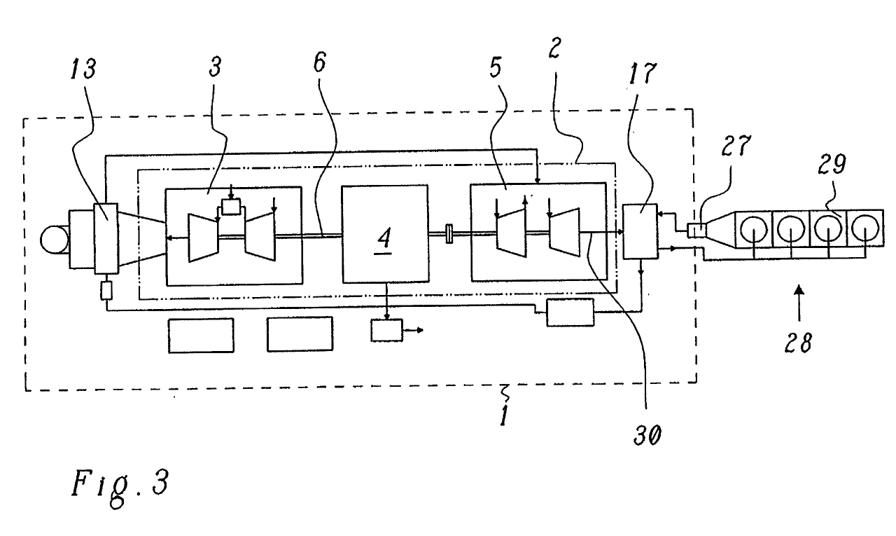

FIG. 3 shows a power island with its own cooling tower in the prolongation of the power train for a combined power station according to a first embodiment example of the invention;

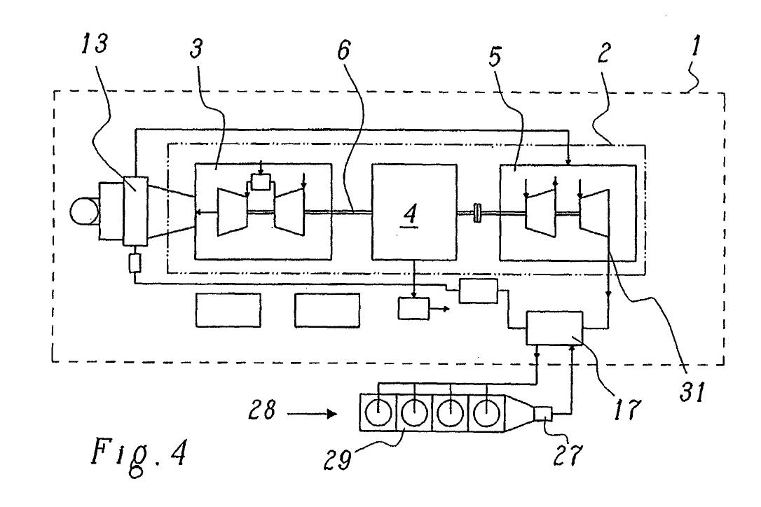

FIG. 4 shows a power island with its own cooling tower beside the power train for a combined power station according to a first embodiment example of the invention;

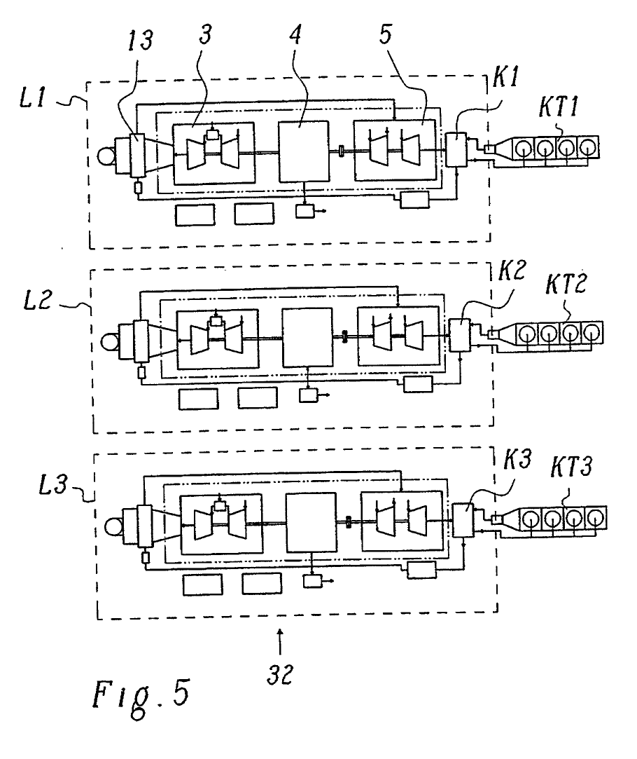

FIG. 5 shows a preferred embodiment example of a combined power station according to the invention with power islands according to FIG. 3;

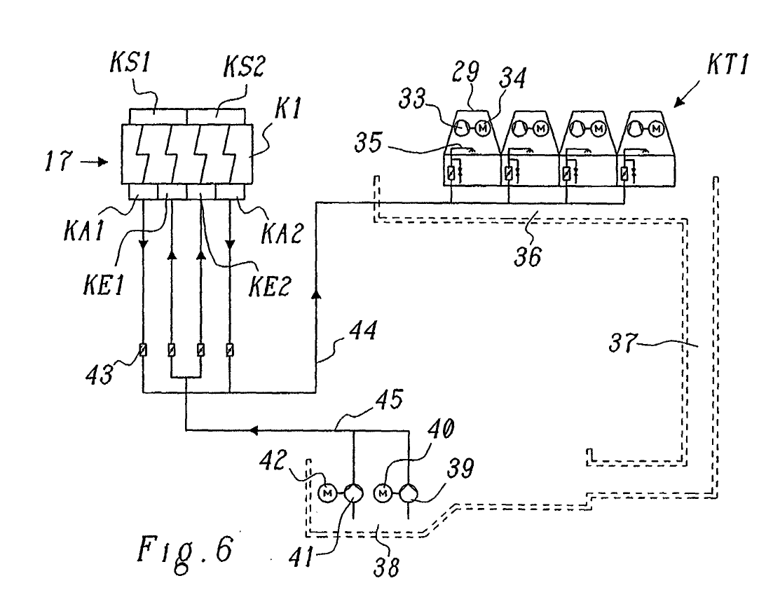

FIGS. 6-8 show various cooling circuits for an individual power island in a combined power station according to the invention.

A simplified diagram, which is comparable with FIG. 1, of a power island with its own cooling tower in the prolongation of the power train for a combined power station according to a first embodiment example of the invention as shown in FIG. 3. The power island 1 with the power train 2 corresponds to the example from FIG. 1 and, for this reason, the same designations are again used for the same parts of the installation. In FIG. 3, the power island 1 has its own cooling tower 28, which is composed of a plurality of cooling tower cells 29, associated with it. The cooling tower 28 is connected to the condenser 17 of the power island 1, thus forming a separate cooling circuit. In the cooling circuit, the cooling water is pumped back from the cooling tower 28 to the condenser 17 by means of one (or more) main cooling water pump(s) 27. The cooling tower 28 is arranged in the (axial) prolongation of the power train 2. This is particularly beneficial in terms of the space sub-division and the mains routing if, in the steam turbine 5, the exhaust steam is rejected by means of an axial exhaust steam outlet 30. If on the other hand—as is shown in FIG. 4—a radial exhaust steam outlet 31 is provided on the steam turbine 5, it is of advantage, for the reasons quoted, for the cooling tower 28 associated with the power island 1 to be arranged beside the power train 2.

A combined power station 32 which is, for example, built up from power islands as shown in FIG. 3, is represented in FIG. 5. Each power island L1, . . . , L3 (1 in FIG. 3) has its own cooling tower KT1, . . . KT3 (28 in FIG. 3), which is respectively connected to the condenser K1, . . . K3 (17 in FIG. 3) of the power islands L1, . . . , L3. This makes it possible, using standardized power islands and cooling towers, to realize a combined power station with the most varied power levels in a simple manner.

A further possibility for standardization arises if the condenser 17 or K1, . . . , K3 of each power island L1, . . . , L3 and the cooling tower KT1, . . . , KT3 and the main cooling water pumps (27 in FIG. 3) for each power island L1, . . . , L3 are laid out so that they are matched in layout and design. A first example of such a matched cooling circuit is reproduced diagrammatically in FIG. 6. The condenser 17 or K1 (whose steam connections and condenser connections are not shown) is sub-divided in this example into two condenser sections KS1 and KS2. Each of the sections can be connected to the cooling circuit by means of a condenser inlet KE1, KE2 and a condenser outlet KA1, KA2. The two condenser outlets KA1, KA2 are connected to the associated cooling tower KT1, which consists of a plurality (in example 4) of cooling tower cells 29 connected in parallel, by means of a common return main 44. A spray appliance 35 and a fan 33 driven by a motor 34 are arranged, in a manner known per se, in each of the cooling tower cells 29. The spray appliances 35 of all the cooling tower cells 29 are connected to the common return main 44. The sprayed cooling water, which is cooled by evaporation and convection, is captured and collected in a sump 36 positioned under the cooling tower cells 29 and supplied via a duct 37 to a pump basin 38 out of which it is pumped by means of two main cooling water pumps 39, 41 driven by motors 40, 42 and supplied via a common supply main 45 and the condenser inlets KE1, KE2 to the condenser sections KS1 and KS2. Standardized power levels can, in this way, be made available by an appropriate selection of the number of condenser sections, main cooling water pumps and cooling tower cells. The number of condenser sections KS1, KS2 is preferably equal to the number of main cooling water pumps 39, 41. The number of cooling tower cells 29 is then, in each case, n times or (n+1) times the number of condenser sections (n=1, 2, 3, . . . ). The use of the common supply main 45 and the common return main 44 makes it necessary to provide valves 43 in the condenser inlets KE1, KE2 and condenser outlets KA1, KA2 of the condenser sections KS1, KS2.

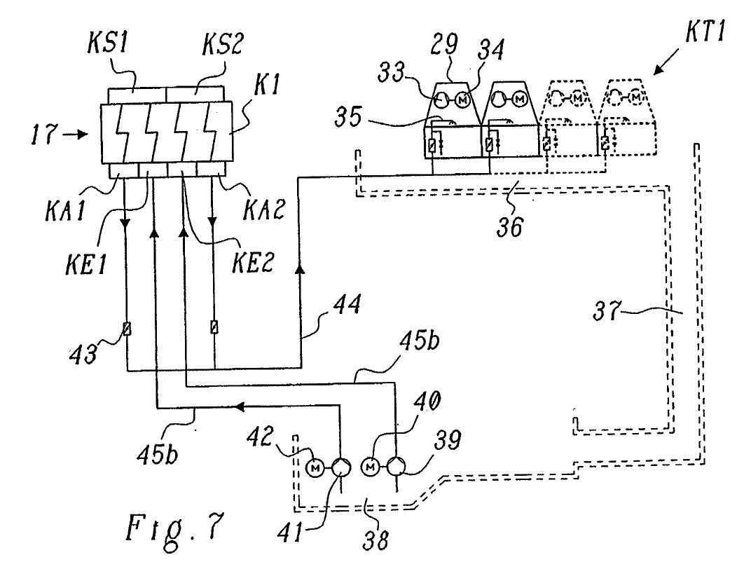

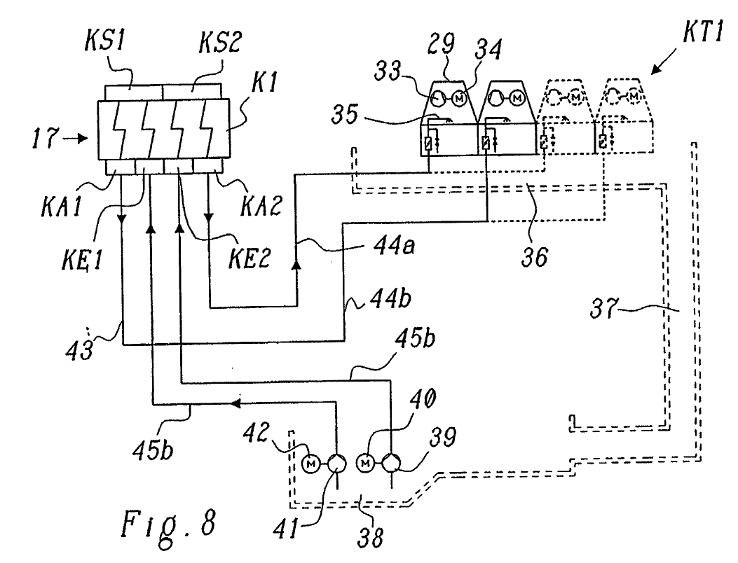

It is possible to dispense with these valves 43 partially or completely if, as shown in FIGS. 7 and 8, separate supply mains 45a, b are supplied instead of the common supply main or separate supply mains and return mains 44a, b and 45a, b are used instead of the common supply mains and return mains. Even further modularization of the cooling circuits is provided by this separation. In FIGS. 7 and 8, dashed lines also indicate that the cooling tower can be optionally equipped with two, four (or more), cooling tower cells 29.

Overall, the invention provides a concept for a combined power station built up from power islands, which combined power station permits increased standardization and therefore simplified installation planning and realization.

List of Designations

1 Power island

2 Power train

3 Gas turbine installation

4 Generator

5 Steam turbine

6 Shaft

7 Coupling

8 Turbine

9 Combustion chamber

10 Compressor

11, 12 Turbine stage

13 Heat recovery steam generator

14 Chimney

15 Feed-water pump

16 Live steam main

17 Condenser

18 Feed-water main

19 Transformer

20, 21 Auxiliary installation

22 Feed-water tank

23, 32 Combined power station

24, 27 Main cooling water pump

25, 28 Cooling tower

26, 29 Cooling tower cell

30 Axial exhaust steam outlet

31 Radial exhaust steam outlet

33 Fan

34 Motor

35 Spray appliance

36 Sump

37 Duct

38 Pump basin

39, 41 Main cooling water pump

40, 42 Motor

43 Valve

44, 44a, b Return main

45, 45a, b Supply main

L1 . . . L3 Power island

K1 . . . K3 Condenser

KA1, KA2 Condenser outlet

KE1, KE2 Condenser inlet

KS1, KS2 Condenser section

KT1 . . . KT3 Cooling tower

1. A combined power station (32) having a plurality of power islands (1; L1, . . . , L3), which operate in 5 parallel and which each comprise a gas turbine installation (3), a steam turbine (5), a generator (4), a water/steam circuit with a heat recovery steam generator (13) and a condenser (17; K1, . . . , K3), and associated auxiliary installations (20, 21), characterized in that each of the power islands (1; L1, . . . , L3) has its own cooling tower (28; KT1, . . . , KT3) associated with it, and that the cooling tower (28; KT1, . . . , KT3) is connected to the respective condenser (17; K1, . . . , K3).

2. The combined power station installation as claimed in claim 1, characterized in that in each of the power islands (1; L1, . . . , L3), the gas turbine installation (3), the steam turbine (5) and the generator (4) are arranged on a shaft (6) and form a power train (2), and in that the associated cooling tower (28; KT1, . . . , KT3) is arranged immediately at the power train (2).

3. The combined power station as claimed in claim 2, characterized in that an axial exhaust steam outlet (30) is provided on the steam turbine (5) of the respective power train (2), and in that the associated cooling tower (28; KT1, . . . , KT3) is arranged as a prolongation of the power train (2).

4. The combined power station as claimed in claim 2, characterized in that a radial exhaust steam outlet (31) is provided on the steam turbine (5) of the respective power train (2), and in that the associated cooling tower (28; KT1, . . . , KT3) is arranged beside the power train (2).

5. The combined power station as claimed in one of claims 1 to 4, characterized in that in the case of individual power islands (1; L1, . . . , L3), the condenser (17; K1, . . . , K3) is subdivided into a plurality of condenser sections (KS1, KS2), a plurality of main cooling water pumps (39, 41) are present and the cooling tower (28; KT1, . . . , KT3) comprises a plurality of cooling tower cells (29) operating in parallel, and in that there is a specified association between the condenser sections (KS1, KS2), the main cooling water pumps (39, 41) and the cooling tower cells (29).

6. The combined power station as claimed in claim 5, characterized in that the main cooling water pumps (39, 41) are in connection with the condenser sections (KS1, KS2) by means of a common supply main (45), and in that the cooling tower cells (29) are in connection with the condenser sections (KS1, KS2) by means of a common return main (44).

7. The combined power station as claimed in claim 5, characterized in that a main cooling water pump (39, 41) is associated with each of the condenser sections (KS1, KS2), and the main cooling water pumps (39, 41) are respectively in connection with the condenser sections (KS1, KS2) by means of separate supply mains (45a, b).

8. The combined power station as claimed in claim 5, characterized in that one or more cooling tower cell(s) (29) is (are) associated with each of the condenser sections (KS1, KS2), and the one or more cooling tower cell(s) (29) are each in connection with the condenser sections (KS1, KS2) by means of separate return mains (44a, b).
